(19) United States
(12) Patent Application Publication
(10) Pub. No.: US 2010/0059653 A1
(43) Pub. Date: Mar. 11, 2010

(54) Resilient Arm and Electronic Apparatus with the Resilient Arm

(75) Inventors: Hung-Chi Chen, Taipei (TW); Chien-Yuan Chen, Taipei (TW); Chia-Te Tsao, Taipei (TW); Chung-Cheng Hua, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: COMPAL ELECTRONICS, INC., Taipei (TW)

(21) Appl. No.: 12/390,613

(22) Filed: Feb. 23, 2009

(30) Foreign Application Priority Data
Sep. 10, 2008 (TW) 97134732

(51) Int. Cl. F16M 13/00

(52) U.S. Cl. 248/617

(57) ABSTRACT

A resilient arm includes an outer frame, a fastening portion, and a first spring. The fastening portion is located in the outer frame and connected to a fixed object. The first spring connects the fastening portion and the outer frame such that the outer frame and the first spring are linked.

### RELATED APPLICATIONS

This application claims priority to Taiwan Application Serial Number 97134732, filed Sep. 10, 2008, which is herein incorporated by reference.

### BACKGROUND

1. Field of Invention

The invention is related to a spring device, more particularly, to a spring device with axial deformation.

2. Description of Related Art

In current mechanical part, a resilient arm is usually implemented to provide appropriate restoring force. In order to satisfy the demand of displacement control, the resilient arm is usually made of metal with good elasticity, and one of the resilient arms is connected with a moving object to provide desired restoring force.

Referring to FIG. 1, which is a schematic graph of a spring arranged on a conventional LCD display. A spring 130 is connected with objects 150 and 170 respectively by means of hooked parts 133 and 135.

While the spring 130 is connected with the objects 150 and 170 respectively by means of the hooked parts 133 and 135, once the hooked part 133 falls down from the object 150 or the hooked part 135 falls down from the object 170, the spring may fall on a printed circuit board (not shown) below. The spring 130 made of metal would make conductive lines on the printed circuit board become short, and cannot function normally.

Therefore, it is desired to design a resilient arm, which could prevent the problem resulting from falling down to provide appropriate restoring force.

### SUMMARY

According to one embodiment of the present invention, a resilient arm includes an outer frame, a fastening portion, and a first spring. The fastening portion is located in the outer frame and connected to a fixed object. The first spring connects the fastening portion and the outer frame such that the outer frame and the first spring are linked.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a schematic graph of a spring arranged on a conventional LCD display.

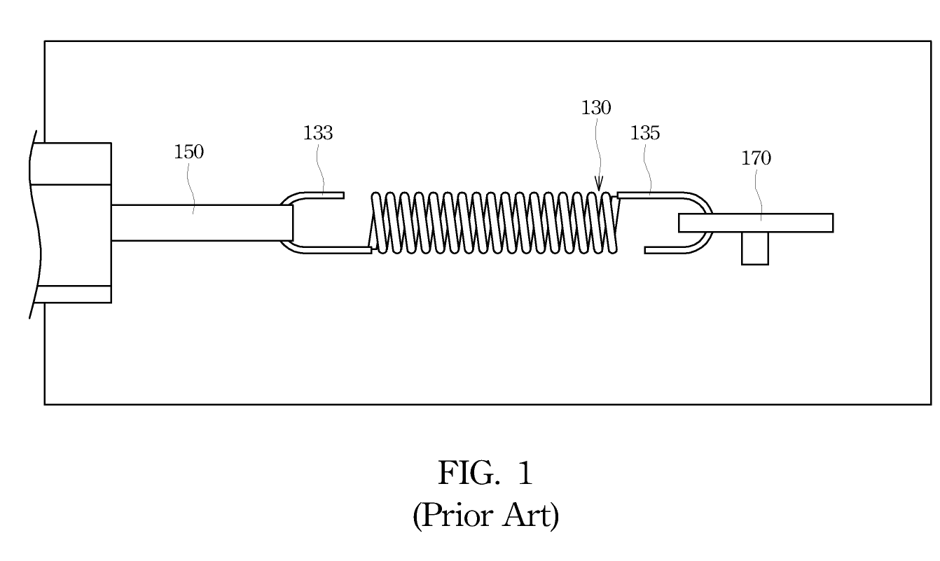

FIG. 2A depicts the structure of a resilient arm according to a first embodiment of the invention.

FIG. 2B depicts the operation of the resilient arm shown in FIG. 2A.

FIG. 3 depicts the structure of a restoring device implementing the resilient arm shown in FIG. 2A.

FIG. 4 is a schematic graph of an electronic apparatus implementing the restoring device of the first embodiment of the invention.

FIG. 5 depicts the structure of a restoring device according to a second embodiment of the invention.

### DETAILED DESCRIPTION

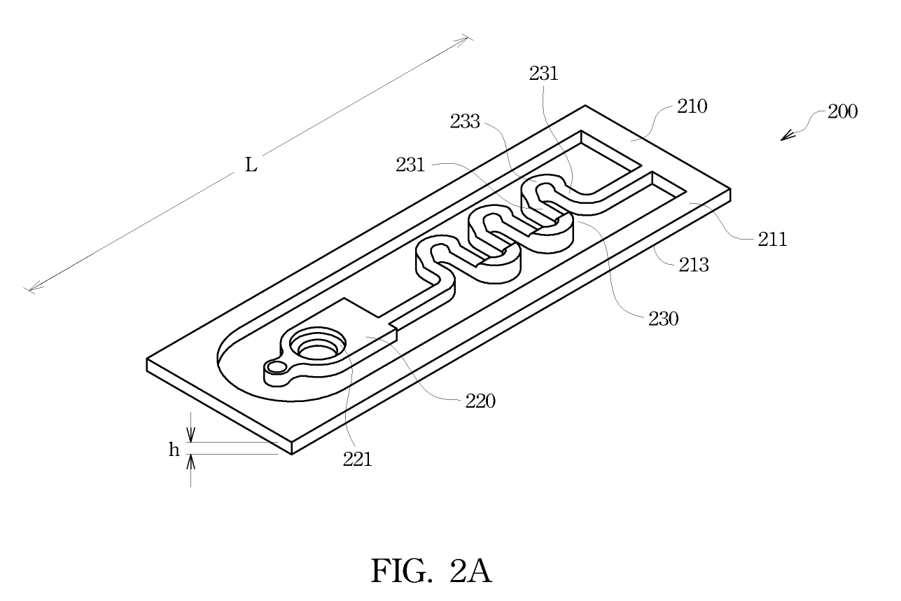

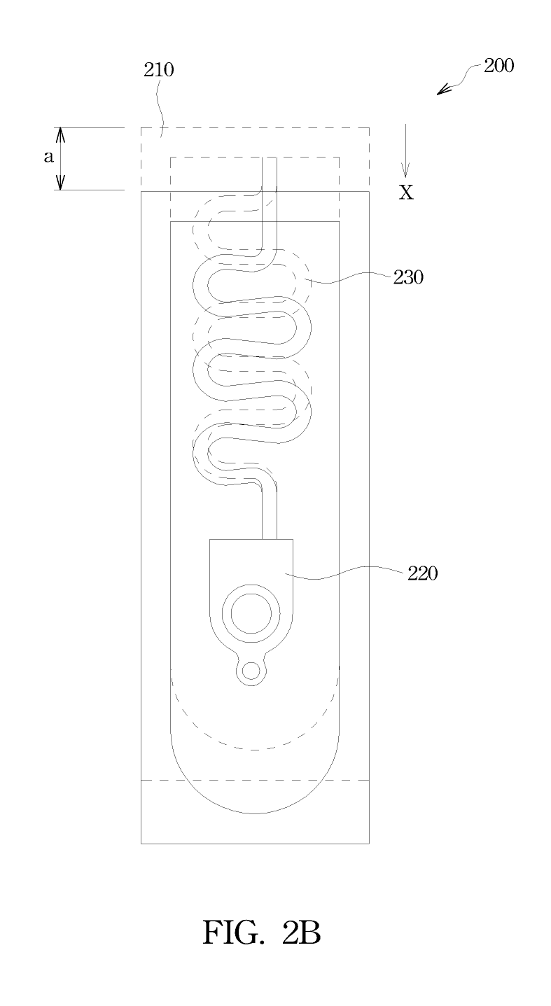

Reference is made to FIG. 2A, which depicts the structure of a resilient arm according to a first embodiment of the invention. A resilient arm 200 includes an outer frame 210, a fastening portion 220, and a first spring 230. The fastening portion 220 is located in the outer frame 210 and connected to a fixed object. The first spring 230 connects the fastening portion 220 and the outer frame 210 such that the outer frame 210 and the first spring 230 are linked. That is, since the outer frame 210 and the first spring 230 are connected with each other, the movement of the outer frame 210 would bring the first spring 230 moving. The outer frame 210, the fastening portion 220, and the first spring 230 are made out of one piece or connected by clips.

The fixed object is referred to an object outside the resilient arm and it would not move with the movement of the resilient arm. The intension of the fixed object below is the same with the description provided here.

The outer frame 210, the fastening portion 220, and the first spring 230 are made out of one piece or connected by clips. Therefore, the resilient arm 200 can be connected in a non-hook way, so as to prevent the spring from falling down.

Moreover, the fastening portion 220 has a hot-melt part 221. This hot-melt part can be welded to the fixed object. Accordingly, the fixed object and the fastening portion would readily connect to each other. When the outer frame is pushed to make a displacement, the fastening portion 220 is still, and the first spring is thus compressed or stretched.

In the embodiment, the first spring 230 has a plurality of non-folded parts 231 arranged opposite each other and at least one folded part 233 connecting the non-folded parts 231. When the fastening portion 220 is still, and the outer frame 210 is pushed to make a displacement, the first spring 230 would be compressed or stretched. And, the distance between the non-folded parts 231 would be deform to be shorter or wider in accordance with the displacement of the outer frame 210.

Furthermore, the folded part 233 may be thicker than the non-folded parts 231, so as to prevent the first spring 230 from breaking during the process of compressing or stretching. The folded part 233 and the non-folded parts 231 are located in the outer frame 210, such that if the shape of the outer frame is a rectangle, compressing or stretching the first spring 230 would make the first spring 230 deform along the direction of the length or height of the rectangle and thus the space for arranging the resilient arm 200 is reduced.

In detail, the outer frame 210 includes a first surface 211 and a second surface 213 oppositely arranged. The first spring 230 and the fastening portion 220 are located between the first surface 211 and the second surface 213 of the outer frame 210. That is, the overall exterior appearance of the outer frame 210, the first spring 230, and the fastening portion 220 is flat, such that the resilient arm 200 would not only provide appropriate restoring force, but also reduce the arranging space needed.

The first spring 230 and the fastening portion 220 are located between the first surface 211 and the second surface 213 of the outer frame 210, and the thickness and the shape of the first spring 230 would vary with the those of the outer frame 210, i.e., the first spring 230 should not be limited to the spring shown in FIG. 2A.

In the embodiment, the resilient arm 200 is made of plastic, the thickness h of the outer frame 210 would be 0.8 mm, the length L of the outer frame 210 would be 40 mm, the thickness of the folded part 233 would be 1.5 mm, and the thickness of the non-folded parts 231 would be 1.2 mm. With such configuration, when the deformation of the first spring 230 is 5 mm, the force applied on the resilient arm 200 would be 0.5 kg, and the stress of the resilient arm 200 is 13.3 Mpa.

The relation between the force applied on the resilient arm 200 and a quantity of the deformation would be similar with a metal spring. However, it should be noted that aforesaid parameters of the thickness h, the length L, the thickness of the folded part 233, and the thickness of the non-folded parts 231 is exemplary only. For those skilled in the art, any variation or modification for the parameters can be made without departing from the scope and sprit of the invention. For example, the minimal thickness of the resilient arm 200 would be 0.6 mm, compared with a resilient arm with a thickness 0.8 mm, a thinner resilient arm may provide a better elasticity, but suffer from a weaker stress-bearing capability.

With reference to FIG. 2B, which depicts the operation of the resilient arm shown in FIG. 2A. The position and the structure of an un-pushed resilient arm is depicted with dash lines. When the outer frame is pushed to make a displacement, the fixed part 220 is still, and the first spring is compressed with a distance a along a direction indicated by the arrow X, and the restoring force possessed by the first spring 230 has a direction reverse with the arrow X.

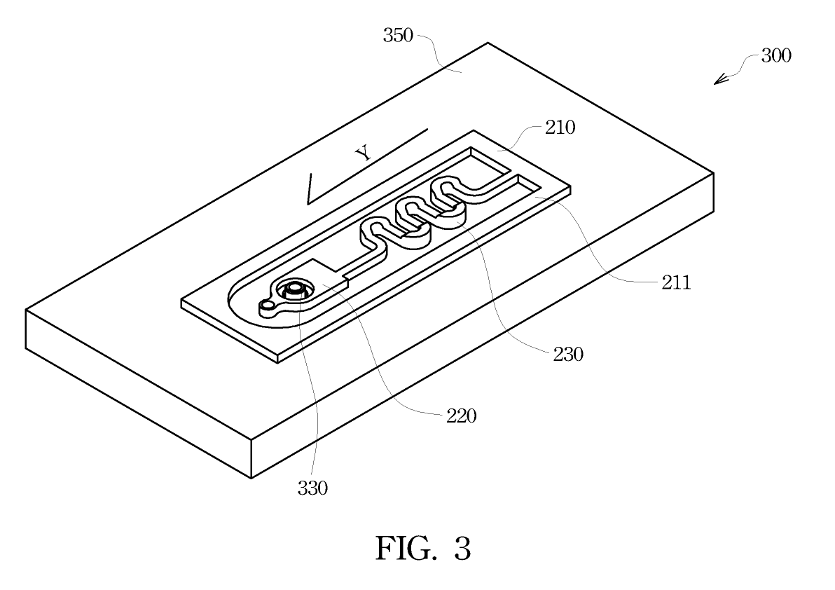

FIG. 3 depicts the structure of a restoring device implementing the resilient arm shown in FIG. 2A. The restoring device 300 has the resilient arm and a fixed object 330. The restoring device 300 is located on the pushed object 350 by means of the second surface 213 opposite to the first surface 211 of the outer frame 210. When a force pushing the pushed object 350 along the direction Y and making a displacement, the fastening portion 220 is adhered on the fixed object 330 and is still. The outer frame 210 would change its position in accordance with the displacement of the pushed object 350, and the first spring 230 connected with the outer frame 210 and the fastening portion 220 will be stretched accordingly.

Once the force pushing the pushed object 350 is removed, the restoring force stored within the compressed or stretched first spring 230 will allow the pushed object to return to its original location.

The restoring device 300 and the resilient arm 200 would be implemented on a variety of apparatuses with elements needed to automatically return to its original location.

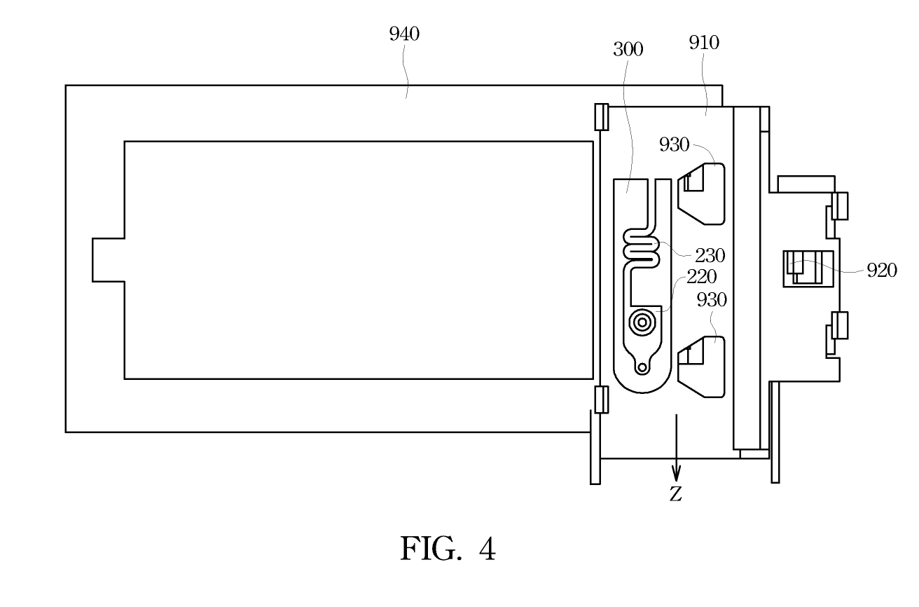

FIG. 4 is a schematic graph of an electronic apparatus implementing the restoring device of the first embodiment of the invention. The outer frame 210 of the resilient arm 300 is adhered on the slipping object 910, the fastening portion 220 is still, and the user would pull a piece member 920 and make the slipping object slip along a direction indicated with the arrow Z, and compress the spring 230 within the resilient arm 300 accordingly. An engaged layer 940 and a snap (not shown) positioned within a T-shape groove 930 would move relatively so as to separate the engaged layer 940 from the snap. After slipping, the kinetic energy stored within the deformed spring 230 will enable the slipping object 910 to return to its original location.

After the force is removed, it is desired that the slipping object 910 would return to original location more rapidly. Another spring is added to increase the restoring force and facilitate the slipping object 910 to return to the original location more rapidly.

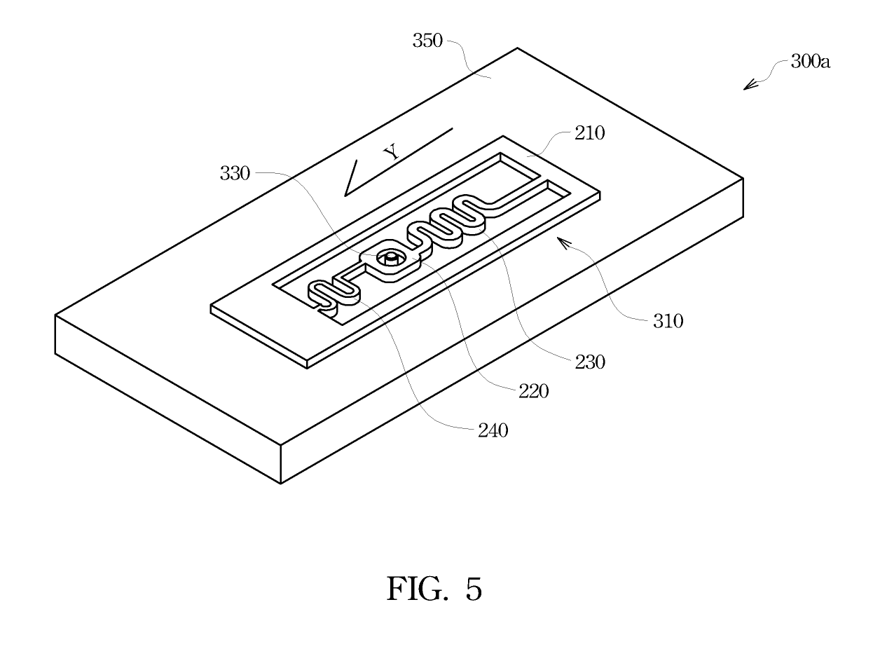

Referring to FIG. 5, which depicts the structure of a restoring device according to a second embodiment of the invention. A restoring device 300a has a resilient arm 310 and a fixed object 330.

Comparing with the resilient arm 200 shown in FIG. 3, the difference between the resilient arm 310 and the resilient arm 200 is that: there is a second spring 240 connecting the fastening portion 220 and the outer frame 210. The fastening portion 220 is located in the outer frame 210 and connected to the fixed object 330. The first spring 240 connects the fastening portion 220 and the outer frame 210, and the second spring 240 connects the fastening portion 220 and the outer frame 210 as well. The outer frame 210, the fastening portion 220, the first spring 230, and the second spring 240 are made out of one piece or connected by clips.

Because the outer frame 210, the fastening portion 220, the first spring 230, and the second spring 240 are made out of one piece or connected by clips, such that it is possible for the resilient arm to be connected in a non-hook way so as to prevent the spring from falling down.

Similarly, in the embodiment, the second spring 240 has a plurality of non-folded parts arranged opposite each other and a folded part connecting the non-folded parts. The folded part of the second spring 240 is thicker than the non-folded parts of the second spring 240, so as to prevent the second spring 240 from breaking during the process of compressing or stretching. The folded part and the non-folded parts of the second spring 240 are disposed in the outer frame 210, such that if the shape of the outer frame is a rectangle, compressing or stretching the first spring 230 would make the first spring 230 deform along the direction of the length or height of the rectangle and thus the space for arranging the resilient arm 200 is reduced.

The restoring device 300a is located on the pushed object 350 by means of the second surface 213 opposite to the first surface 211 of the outer frame 210. When a force pushing the pushed object 350 along the direction Y to make a displacement, the fastening portion 220 is adhered on the fixed object 330 and is still. The outer frame 210 would change its position in accordance with the displacement of the pushed object 350, and the first spring 230 and the second spring 240 connected with the outer frame 210 and the fastening portion 220 will be respectively stretched and compressed accordingly.

Once the force pushing the pushed object 350 is removed, the restoring force stored within the compressed or stretched first spring 230 and the second spring 240 will allow the pushed object 350 to return to its original location.

Moreover, because the first spring 230 and the second spring 240 are located in the outer frame 210 and respectively connected to opposite sides of the fastening portion 220, when the displacement of the pushed object 350 resulting from the force exists, the total restoring force is equal to the summation of the restoring forces stored within the first spring 230 and the second spring 240.

Additionally, the elastic modulus of the first spring 230 is greater than the elastic modulus of the second spring 240. Comparing the condition of the first spring 230 and the second spring 240 both having the same elastic modulus, the force applied on the pushed object 350 to make the same displacement would be smaller. The elastic modulus of the first spring 230 and the second spring 240 should be adjusted in accordance with application requirements for the restoring device and the resilient arm 300a. If the pushed object 350 is desired to return to its original location rapidly, the elastic modulus of the first spring 230 and the second spring 240 should be raised. Considering the user moving the pushed object 350 with only a small force, the elastic modulus of the first spring 230 and the second spring 240 should be reduced.

Because a plastic material has characteristics of easy manufacturing, high plasticity and cheaper cost, the resilient arm provided by the first embodiment and the second embodiment is made of the plastic material. As a result, once the resilient arm falls down on the circuit board, the resilient arm would not cause shorting problems and the circuit board may still operate normally.

With embodiments described above, implementing the restoring device and resilient arm provided would prevent the spring from falling down from hooked positions to the circuit board, and reduce the space for arranging the restoring device and the resilient arm.

While the present invention has been described with respect to the embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

What is claimed is:

1. A resilient arm comprising:
an outer frame;
a fastening portion located in the outer frame and connected to a fixed object; and
a first spring connecting the fastening portion and the outer frame such that the outer frame and the first spring are linked.

2. The resilient arm of claim 1, wherein the fastening portion comprises:
a hot-melt part welded to the fixed object.

3. The resilient arm of claim 1, wherein the first spring comprises:
a plurality of non-folded parts arranged opposite each other; and
at least one folded part connecting the non-folded parts.

4. The resilient arm of claim 3, wherein the folded part is thicker than the non-folded parts.

5. The resilient arm of claim 3, wherein the non-folded parts and the folded part are located in the outer frame.

6. The resilient arm of claim 1, further comprising:
a second spring connecting the fastening portion and the outer frame.

7. The resilient arm of claim 6, wherein the first spring and the second spring are located in the outer frame and respectively connected to opposite sides of the fastening portion.

8. The resilient arm of claim 6, wherein the second spring comprises:
a plurality of non-folded parts arranged opposite each other; and
at least one folded part connecting the non-folded parts.

9. The resilient arm of claim 8, wherein the folded part is thicker than the non-folded parts.

10. The resilient arm of claim 6, wherein the elastic modulus of the first spring is greater than the elastic modulus of the second spring.

11. The resilient arm of claim 1, wherein the outer frame comprises two surfaces oppositely arranged, and the first spring and the fastening portion are located between the surfaces of the outer frame.

12. The resilient arm of claim 1, wherein the outer frame, the fastening portion, and the first spring are made out of one piece.

13. An electronic apparatus comprising:
a slipping object disposed in the electronic apparatus; and
a resilient arm adhered on the slipping object, the resilient arm comprising:
an outer frame;
a fastening portion located in the outer frame and connected to a fixed object; and
a first spring connecting the fastening portion and the outer frame such that the outer frame and the first spring are linked.
